(19) United States
(12) Patent Application Publication
(10) Pub. No.: US 2011/0179833 A1
(43) Pub. Date: Jul. 28, 2011

(54) U-LOCK

(75) Inventors: Darrell Robinson, Waterford, MI (US); Allen Pruehs, Howell, MI (US)

(73) Assignee: EKSTROM INDUSTRIES, INC., Farmington Hills, MI (US)

(21) Appl. No.: 12/704,603

(22) Filed: Feb. 12, 2010

Related U.S. Application Data
(60) Provisional application No. 61/298,764, filed on Jan. 27, 2010.

(51) Int. Cl. E05B 67/02; E05B 67/06; B23P 11/00

(52) U.S. Cl. 70/52; 29/428

(57) ABSTRACT

A lock apparatus includes a lock body which is slidably mountable over the legs of the shackle. At least one push nut is mounted within a recess carried in the lock body to allow easy insertion of the legs of the shackle through the bores in the lock sections and the at least one push nut, but exerts a substantial force resisting separation of the lock body from the shackle in an opposite direction. The lock body is formed of a unitary one-piece body, or a pair of identical lock sections which are reoriented with respect to each other and inter-engaged to form bores at one edge which receive the legs of the shackle. A method of installing the lock apparatus includes mounting at least one push nut in a lock body and then inserting the legs of the shackle through bores in the lock body and the at least one push nut.

### CROSS REFERENCE TO CO-PENDING APPLICATION

This application claims priority benefit to the filing date of co-pending U.S. Provisional Patent Application Ser. No. 61/298,764 filed on Jan. 27, 2010, the entire contents of which are incorporated herein in its entirety.

### BACKGROUND

Locks, such as padlocks, come in various styles and shapes; but are all used to removably lock one article to another.

In the electrical utility industry, lock devices, which function as security seals, are used to lock a transformer or meter socket enclosure. Such utility locks or seals provide a locking function for a utility enclosure; but are easily broken or cut apart. The intent of such lock-like seals is to provide a visual indication of tampering with the utility power enclosure.

A typical utility lock or seal has a U-shaped shackle with two spaced, parallel legs interconnected at one end by a central end section. The legs of the shackle are inserted into two bores in a lock body. A set screw is threaded through at least side of the body into tight engagement with one of the shackle legs to lock the shackle and lock body together.

The set screw requires the use of a tool, such as a screw driver, wrench, pliers or channel locks, to thread the screw into tight engagement with the shackle and, with sufficient force, to break the head of the set screw off of the shank at a frangible portion of the shank. Bolt cutters are thereby required to remove the lock by cutting the shackle. Alternately, the lock body has to be destroyed to separate the lock body from the shackle.

It will be desirable to provide a lock and, in particular, a utility enclosure lock which has a low manufacturing cost and which can be engaged in a locked position without the use of a tool.

### SUMMARY

In one aspect, a lock apparatus includes a shackle having a pair of spaced legs. A lock body includes a pair of spaced bores for receiving the legs of the shackle. At least one push nut is carried within the lock body for receiving the legs of the shackle in a unidirectional insertion direction. The lock body may carry two push nuts, one for engaging each shackle leg.

In one aspect, the lock body is an integral one-piece unitary body. At least one or two cavities are formed internally within the one piece body and open to slots extending from one surface of the lock body. A push nut is inserted through each slot into the cavity.

In another aspect, the lock body includes first and second inter-engageable sections. Each of the first and second sections has first and second spaced ends. Apertures are formed in at least one of the first and second ends of each section. The apertures are coaxially aligned when the first and second sections are inter-engaged to form bores opening to the inter-engaged sections of the lock body.

In one aspect, pairs of bores are formed on opposite side edges of the lock sections to enable the legs of the shackle to pass freely through the entire lock body. In another aspect, the lock body forms a closed interior chamber which completely encompasses the ends of the legs of the shackle when the shackle is interconnected with the lock body.

Each of the first and second sections includes a first a pair of sidewalls at a first end and second pair of sidewalls at a spaced second end. The first and second sidewalls of each of the first and second sections are connected to a unitary member. Coaxially aligned apertures are formed in each of the first and second pairs of sidewalls.

First and second recesses are formed in the first and second sections between the first and second pairs of sidewalls. The first and second recesses are coaxially aligned with the apertures in the sidewalls. One push nut is mounted into each of the first and second recesses.

Each recess in the first and second sections cooperates with a like recess in the opposing first and second section when the first and second sections are inter-engaged to substantially encompass one push nut.

In one aspect, the first and second sections are substantially identical. This enables the first and second sections to be reoriented with respect to each other such that the first pair of sidewalls on each of the first and second sections are laterally opposed from the second pair of sidewalls of the opposed first and second section.

The second pair of sidewalls of each of the first and second sections may be laterally spaced closer together than the lateral spacing of the first pair of sidewalls such that the first pair of sidewalls encompasses the second pair of sidewalls when the first and second sections are inter-engaged.

Engagement members may be carried on the first and second sections for cooperating with like engagement members on the opposing first and second sections when the first and second sections are inter-engaged to resist separation of the first and second sections. The engagement members may be a plurality of spaced, uni-directional angled teeth.

In another aspect, a method of installing a lock including a shackle having spaced legs engageable with a lock body. The method comprises the steps of providing a lock body having a pair of spaced bores for receiving the legs of the shackle; mounting at least one push nut within the lock body for receiving the legs of the shackle in a unidirectional insertion direction; and inserting the legs of the shackle in one direction through the bores in the lock body such that the push nut forcibly engages one leg of the shackle to resist separation of the legs of the shackle from the lock body in a direction opposite from the insertion direction.

In one aspect, the method includes the step of providing a one piece, unitary lock body having at least one internal cavity for receiving a push nut. A slot extends from an outer surface of the lock body into the cavity to allow insertion of a push nut through the slot into the cavity.

In another aspect, the shackle and the lock body are formed of a castable metal. The end of at least one leg of the shackle is frangibly connected to the lock body during casting of the shackle and the lock body.

In another aspect, the method comprises the step of providing a lock body formed of first and second inter-engageable sections.

The method also includes the steps of forming a pair of recesses in each section; mounting a push nut in each of the recesses and inter-engaging the sections to form a unitary lock body with the recesses in each of the sections cooperating to substantially encompass one push nut therebetween.

The method also includes the step of forming the lock body to define a closed interior chamber which completely encompasses the ends of the shackle legs when the shackle is interconnected with the lock body for added security.

### BRIEF DESCRIPTION OF THE DRAWING

The various features, advantages and other uses of the present invention will become more apparent by referring to the following detailed description and drawing in which:

FIG. 1 is a perspective view of a lock body;

FIG. 2 is an exploded, perspective view of the lock body shown in FIG. 1;

FIG. 3 is a side perspective view of one of the two lock body sections;

FIG. 4 is a side elevational view of the one lock body section shown in FIG. 3 with the insertion of one push nut therein;

FIG. 5 is a partially transparent, perspective view showing the internal push nuts in the assembled lock sections;

FIG. 6 is a cross-sectional view generally taken along line 6-6 in FIG. 5;

FIG. 7 is a front elevational view, partially in cross section, of the lock body shackle engaged with two hasp;

FIG. 8 as a perspective view of another aspect of a lock body, shown with the shackle integrally attached to the lock body after a die casting operation;

FIG. 9 is a front elevational view of the lock body shown in FIG. 8

FIG. 10 is a bottom elevational view of the lock body shown in FIG. 8;

FIG. 11 is a cross-sectional view through the lock body showing the mounting of one push nut in the lock body and the engagement of the push nut with the shackle;

FIG. 12 is a perspective view of another lock with a two section lock body;

FIG. 13 is an exploded perspective view showing the two section lock body, with the push nuts mounted in one of the lock body sections; and

FIG. 14 is an enlarged, perspective view of the entire lock depicted in FIGS. 12 and 13 with one of the lock body sections shown in phantom.

### DETAILED DESCRIPTION

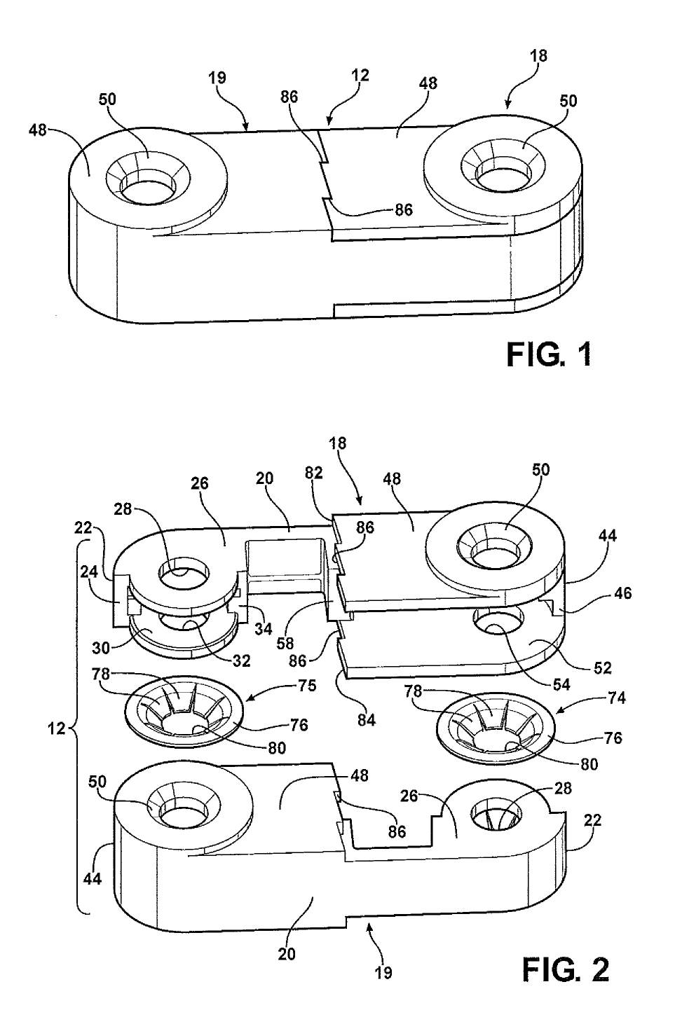

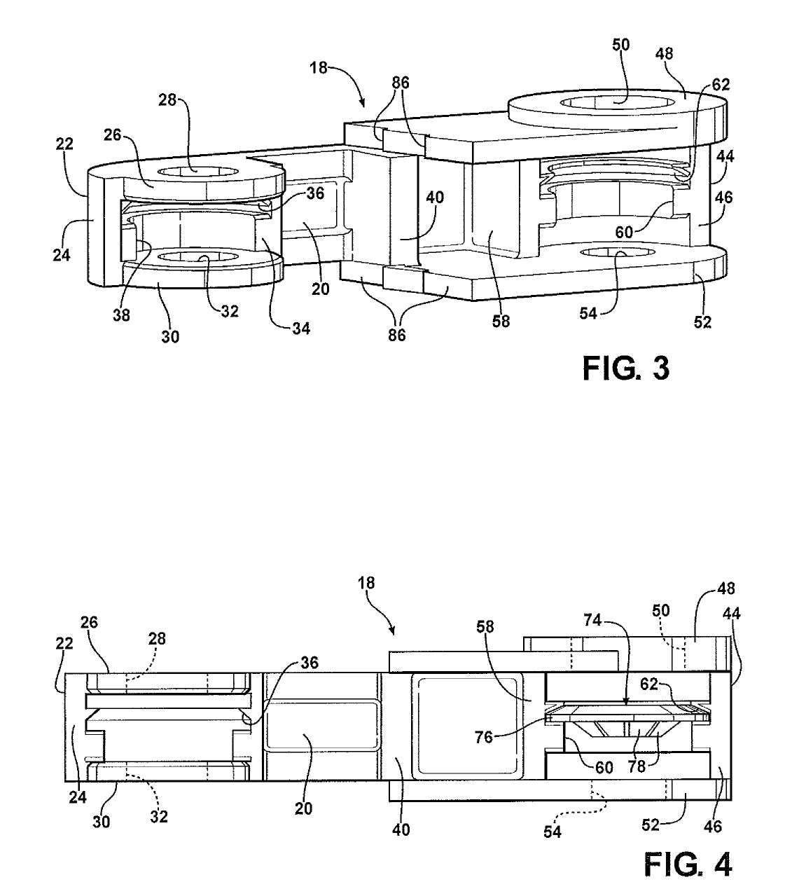

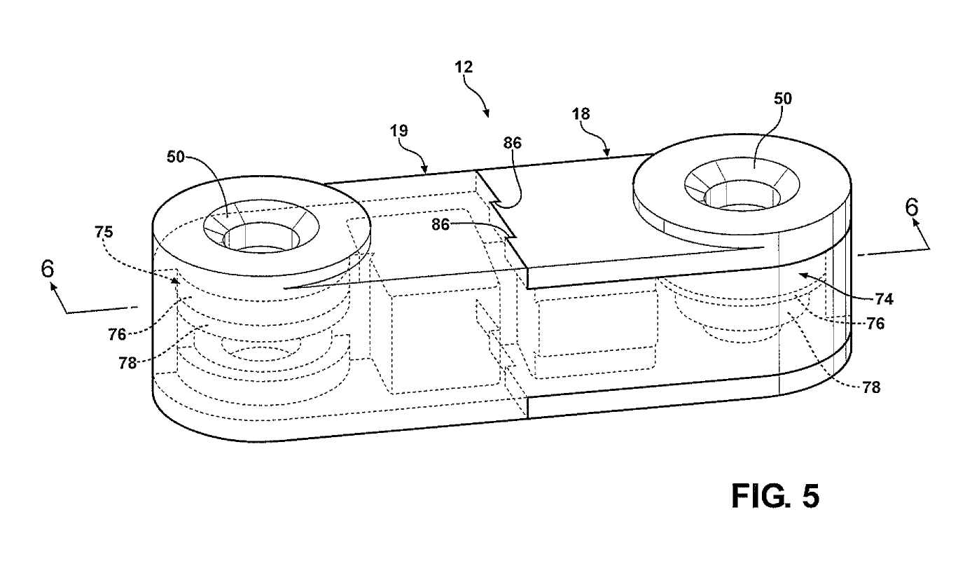

Referring now to FIGS. 1-7 there is depicted one aspect of a lock assembly or lock 10 formed of a lock body 12 and a shackle 14.

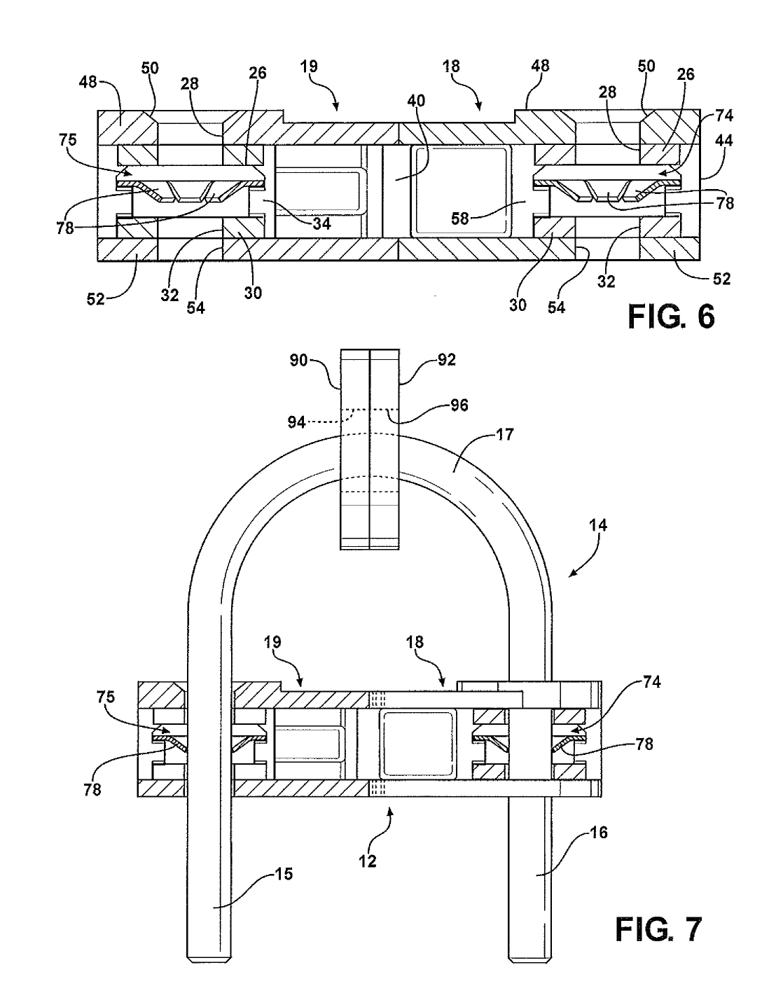

As shown in detail in FIG. 7, the shackle 14 is typically formed of metal and has two spaced parallel legs 15 and 16 which are unitarily connected at one end by a central bight section 17.

Referring back to FIGS. 1-6, the lock body 12 includes a first lock section 18 and a second lock section 19 which are interconnectably engaged to form the complete lock body 12. One of the features of the lock body 12 which contributes to its low manufacturing cost is that the first and second sections 18 and 19 are identically constructed. Thus, the following description of the construction of the first and second lock sections 18 and 19 will be provided in detail only for the first lock section 18, it being understood that the second lock section 19 is identically constructed.

The first lock section 18 is formed of a unitary body, such as a die cast metal, plastic, etc. The first lock section 18 includes a wall 20 extending from a first end 22 in the form of a curved outer endwall 24. A first sidewall 26 projects angularly, such as perpendicularly, from the wall 20 adjacent to the first endwall 24. An aperture 28 is formed in the first sidewall 26.

A second sidewall 30 project from the opposed edge of the wall 20 adjacent to the first end 22 generally parallel to the first sidewall 26. A through aperture 32 is formed in the second sidewall 30.

An interior wall 34 projects from the outer wall 20 between the first and second sidewalls 26 and 30 and is spaced from the first endwall 24. A first conical recess 36 is formed in the wall 20 between the first endwall 24 and the interior wall 34. A larger arcuate recess 38 is also formed between the first endwall 24 and the interior wall 34 co-axial with the conical recess and the apertures 28 and 32.

An intermediate strengthening wall 40 is provided on the outer wall 20 spaced from the interior wall 34.

A second end 44 is formed on the wall 20 in the form of an arcuate outer end wall 46. An inner wall 58 also extends from the wall 20 spaced from the second endwall 46.

A third sidewall 48 extends angularly, such as perpendicularly, from the outer wall 20 between the second endwall 46 and the second interior wall 47. A first aperture 50 is formed in the third sidewall 48. A similar fourth sidewall 52 is spaced generally parallel from the third sidewall 48 and extends angularly from the outer wall 20 between the second endwall 46 and the second interior wall 47. An aperture 54 is formed in the fourth sidewall 52.

A conical recess 62 is formed between the second endwall 46 and the second interior wall 58. Similarly, an arcuate recess 60 is positioned co-axially to the conical recess 62 between the second endwall 46 and the second interior wall 50. The recesses 60 and 62 are coaxial with the apertures 50 and 54 in the pair of parallel third and fourth sidewalls 48 and 52.

As shown in FIGS. 2 and 4, two lock or push nuts 74 and 75, which can be PAL push nuts, for example each have an annular disc 76 with a plurality of spring fingers 78 extending angularly away from one side of the disc 76. The inner ends of the spring finger 78 define a central aperture 80 through the push nut 74 or 75.

As shown in FIGS. 4-7, the disc portion 76 of one push nut 74 is inserted into the conical recess 36 between the pair of first and second sidewalls 26 and 30. It will also be understood that the push nuts 74 and 75 can be inserted into the die cast mold for insert casting with the molding with one of the first and sections 18 or 19.

The disc 76 of the other push nut 75 is inserted into the conical recess 62 between the third and fourth sidewalls 48 and 52. In this orientation, shown in FIG. 4, the spring fingers 78 extend into the annular recesses 38 and 60 at opposite ends of the first lock section 18.

As shown in FIG. 2, when assembling the lock body 12, one of the first and second sections 18 and 19, with the second section 19 being used in this explanation by way of example only, is inverted with respect to the first lock section 18 such that the first end 22 of the second lock section 19 is spaced from the second end 44 of the first lock section 18, and the second end 44 of the second lock section 19 is spaced from the first end 22 of the first lock section 18.

The first and second lock sections 18 and 19 are then urged together to form the unitary lock body 12. Since the conical recesses 36 and 62 and the arcuate recesses 38 and 60 have a hemispherical form in each individual first and second lock sections 18 and 19, the recesses 62 and 60 in the second lock section 19 will slide over the projecting portions of the push nuts 74 and 75 to capture the push nuts 74 and 75 between the interconnected first and second lock sections 18 and 19.

It should also be noted that the spacing between the pair of first and second sidewalls 26 and 30 is less than the spacing between the pair of third and fourth sidewalls 48 and 52. This enables the pair of sidewalls 48 and 52 of each lock section 18 and 19 to slide over the first and second sidewalls 26 and 30 of the opposed lock section 18 and 19.

As shown in FIGS. 1 and 2, inner edges 82 and 84 of the first and second sidewalls 26 and 30, respectively, have an engagement or locking profile. By way of example, the engagement profile can be provided as a plurality of angled teeth 86 extending along the length of each of the inner edges 82 and 84. As shown in FIG. 1, the teeth 86 have a directional offset such that the inversion of one lock section, such as the second lock section 19, with respect to the first lock section 18 during the assembly of the lock body 12 will bring the teeth 86 into mating engagement resisting sideways separation of the joined lock sections 18 and 19.

Referring now to FIG. 7, the installation of the entire lock 10 in a locking position will be described. A pair of hasps or flanges 90 and 92, each having a through aperture 94 and 96, respectively, extend outward from two movable doors or one door and a stationary portion of a utility enclosure, not shown. When the door or doors are in the locked position, the apertures 94 and 96 align thereby enabling the shackle 14 to be inserted through the apertures 94 and 96. The lock body 12 is then forcibly urged over the legs 15 and 16 of the shackle 14 by inserting the ends of the legs 15 and 16 of the shackle 14 through the aligned apertures 28 and 32, and 50 and 52 in the joined locked sections 18 and 19. During this insertion, the legs 15 and 16 of the shackle 14 pass through the apertures 80 in the push nuts 74 and 75 and bend the inner ends of the spring fingers 76 slightly outward. However, the spring fingers 78 remained in an inward angled position relative to the respective discs 76 so as to bite into and prevent opposite sliding movement to separate the legs 15 and 16 of the shackle 14 from the lock body 12.

It will also be understood that the lock 10 is also completely functional when only one lock nut 74 or 75 is mounted within the joined sections of the lock body 12.

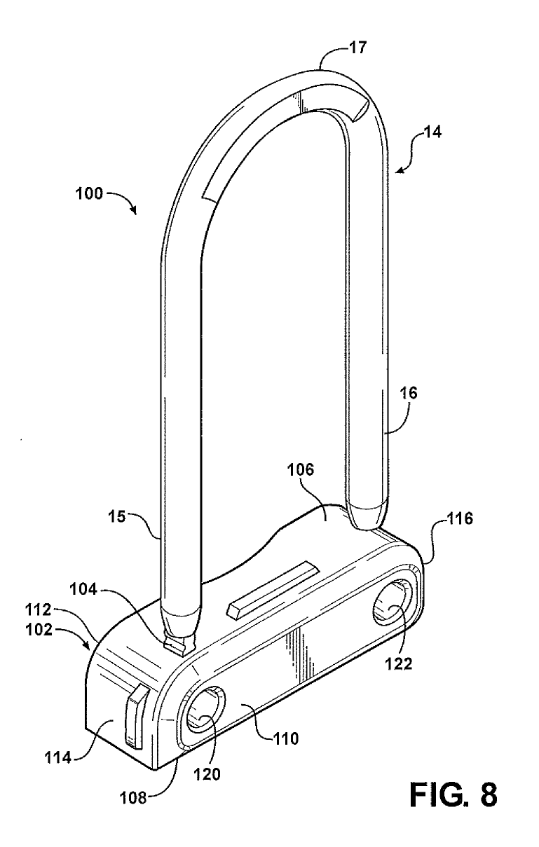

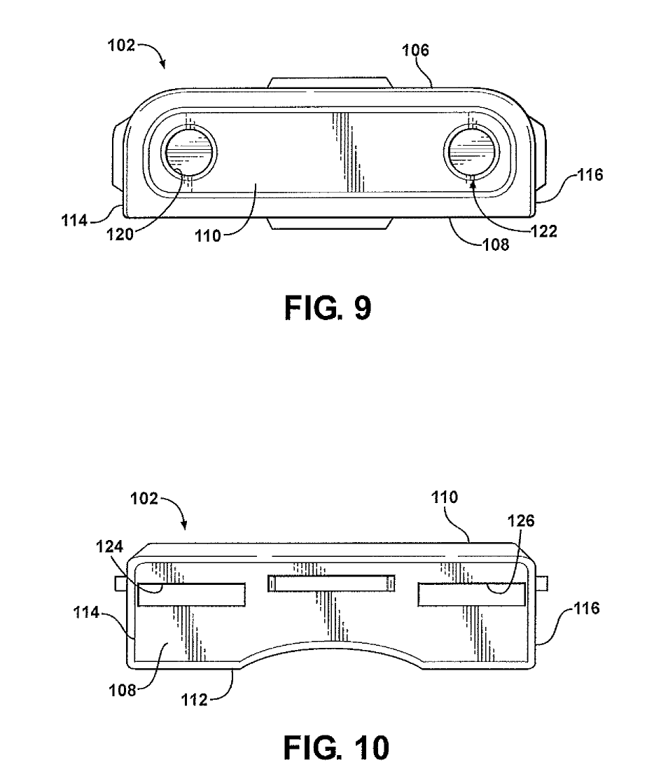

Referring now to FIGS. 8-11, there is depicted another aspect of a lock apparatus 100. The lock apparatus 100 includes a shackle 14 identical to the shackle described above and shown in FIGS. 1-8. The lock apparatus 100 also includes a lock body 102.

In this aspect, by way of example only, the shackle 14 and the lock body 102 are integrally formed of a castable metal in a die cast operation. As shown in FIG. 8, the shackle 14 and the lock body 102 are integrally formed as a one piece assembly where one leg 15 of the shackle 14 is integrally coupled to the lock body 102 by a frangible portion 104. This frangible portion 104 enables the shackle 14 to be separated from the lock body 102 for use.

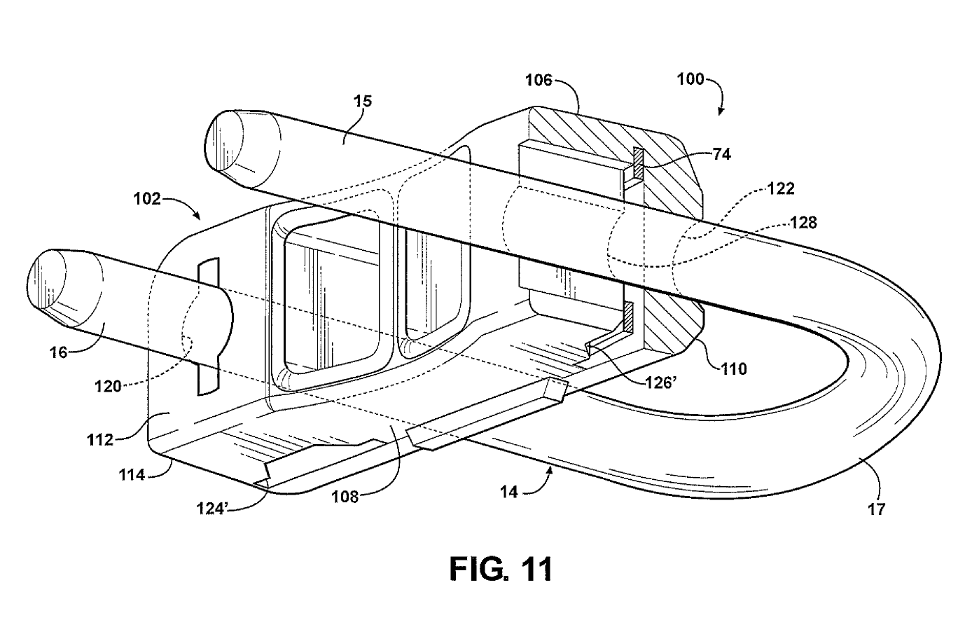

As shown in FIGS. 8-11, the lock body 102 has a general rectangular profile, cubicle shape formed of a top surface 106, an opposed, bottom surface 108, a front surface 110, an opposed rear surface 112, and opposed side surfaces 114 and 116 in the orientation shown in FIG. 8. A pair of through bores 120 and 122 extends through the lock body 102 between the front surface 110 and the rear surface 112. The bores 120 and 122 intersect a pair of slots 124 and 126, respectively, each of which extends from an open end in the bottom surface 108 into the interior of the lock body 102 as shown in detail in FIG. 11.

Each slot 124 and 126 opens to an enlarged cavity 128 within the lock body 102. The cavity 128 is centered about the respective through bore 120 or 122. The slots 124 and 126 shown in FIG. 11 have a cross section approximate that of the push nut 74 by example only.

Each cavity 128 is configured for receiving one push nut 74 inserted through one of the slots 124 and 126; with the push nut 74 being inserted into the slot 126 in the example shown in FIG. 11. The slots 124 and 126 have a cross section slightly smaller than the height of the push nut 74. During the insertion and step, the spring fingers 78 on each push nut 74 or 75 are compressed slightly to fit through the narrow slot 124 and 126. Once the push nut 74 is fully inserted within each cavity 128, the spring fingers 78 relax and expand back to their original shape. This coaxially aligns the aperture 80 between the inner ends of the spring fingers 78 of each push nut 74 and 75 with the respective through bore 120 and 122 in the lock body 102.

It will also be understood that the slots 124 and 126 may be eliminated and the push nuts 74 and 75 integrally cast within the cavity 128 in the lock body 102 during the die casting of the lock body 102.

During installation, after the shackle 14 has been separated from the lock body 102, the shackle 14 can be inserted through the surfaces to be locked, such as the hasps 90 and 92 shown in FIG. 7. The lock body 102 is then oriented with respect to the shackle 14 to place the front surface 110 facing toward the ends of the shackle legs 15 and 16.

The lock body 102 and the shackle 14 are then engaged by inserting the shackle legs 15 and 16 into the bores 120 and 122 in the lock body or by urging the bores 120 and 122 of the lock body 102 over the ends of the shackle legs 15 and 16.

During the insertion step, the shackle legs 15 and 16 pass through the one or more push nuts 74 mounted in the cavities 128 in the lock body 102 causing the inner ends of the spring finger 78 to expand outward.

The insertion step continues until the installer is satisfied with the placement of the lock body 102 along the length of the shackle legs 15 and 16. In this position, as shown in FIG. 11, the spring fingers 78 of the one or more push nuts 74 or 75 resist separation of the lock body 102 from the shackle 14 in a direction opposite from the insertion direction. In order to separate the lock body 102 from the shackle 14, one or both of the shackle legs 15, 16 has to be cut, such as through the use of bolt cutters, or the lock body 102 has to be destroyed.

It has been found that the assembly of the lock 10 can be completed without a tool and using only 15-25 pounds of insertion pressure to engage the lock body 12 or 102 with the shackle 14. However, the push nuts 74 and 75 captured with the lock body 12 or 102 exert sufficient resistance to separation of the legs 15 and 16 of the shackle 14 from the lock body 12 that 400 pounds of pull out force are required on each leg 15 and 16 of the shackle 14 to pull each leg 15 or 16 from the lock body 12 or 102.

It should also be noted that the engagement of the shackle legs 15 and 16 with the push nuts 74 and 75 retains the first and second lock sections 18 and 19 of the lock body 12 together in non-separating engagement.

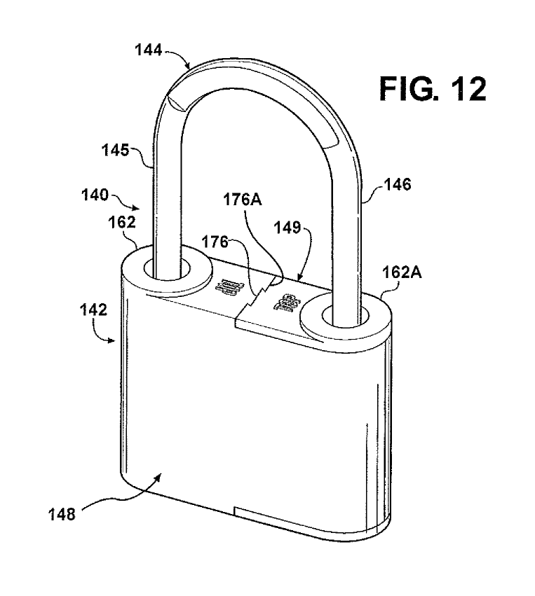

Referring now to FIGS. 12-14, there is depicted another aspect of a lock 140 formed of a lock body 142 and a shackle 144. In this aspect, the shackle 144 may be identical to the shackle 14 shown in FIG. 8. The shackle 144 may have shorter length legs 145 and 146 for secure fitting within the lock body 142 as described hereafter.

As in the first aspect of the lock 10 shown in FIGS. 1-7, the lock body 142 is formed of substantially identical lock sections 148 and 149. Each lock section 148 and 149 is formed of a unitary body, such as a one-piece body formed of die cast metal, plastic, etc.

As both of the first and second lock sections 148 and 149 are substantially identical, the following description of the first lock section 148 will be understood to apply equally to the second lock section 149. In the following description of the assembly of the first and second lock sections 148 and 149, like elements of the second lock section 149 will be given the same reference number as the corresponding element of the first lock section 148, along with an “A” suffix.

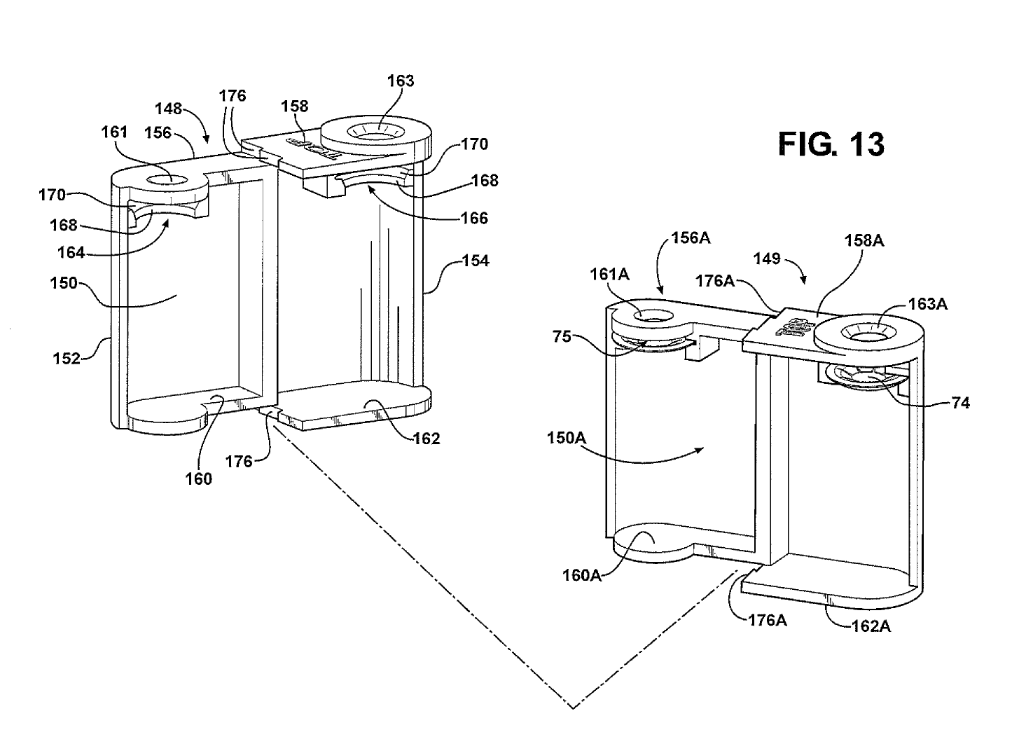

As shown in detail FIG. 13, the first lock section 148 includes a sidewall 150 extending between a first edge 152 and an opposed second edge 154. A first endwall formed of stepped sections 156 and 158 is formed along one side edge of the sidewall 150. A similar second endwall formed of stepped sections 160 and 162 extends along the opposite side edge of the sidewall 150.

Each of the stepped sections 156 and 158 includes a through bore 161 and 163, respectively. Each through bore 161 and 163 is coaxially aligned with a push nut seat 164 and 166, respectively, formed on the sidewall 150 immediately adjacent to the stepped sections 156 and 158.

Similar to the push nut seats described above and shown in the first aspect of the lock 10 in FIGS. 1-7, the push nut seats 164 and 166 include a conical recess 168 and an enlarged diameter, annular recess 170. The annular recess 170 is adapted for receiving the enlarged annular end of one push nut 74 or 75. The annularly bent spring fingers 78 of each push nut 74 and 75 are seated within the conical recesses 168.

In this manner, the push nuts 74 and 75 may be inserted into the push nut seats 164 and 166 formed in either of the first and second lock sections 148 and 149 as shown in FIG. 13, prior to the interconnection of the first and second lock sections 148 and 149.

As seen in FIG. 13, the endwall sections 156 and 160 are spaced closer together than the adjacent endwall sections 158 and 162. This enables the first and second lock sections 148 and 149 to be reversed in orientation with respect to each other, as shown in FIG. 13, and then snapped engaged into a locked position surrounding the push nuts 74 and 75

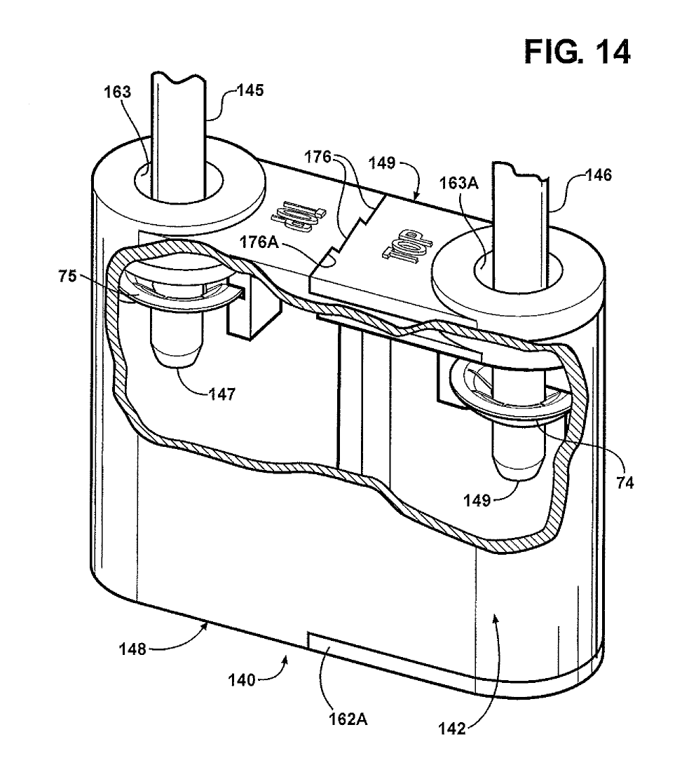

Similar to the engagement or locking profile for the lock sections of the lock body 12 shown in FIGS. 1 and 2, the lock sections 148 and 149 have an engagement or locking profile provided by a plurality of angled teeth 176, 176A along the edge of the stepped sections 156 and 158 and along the edge of the stepped sections 160 and 162. The orientation of the first and second lock sections 148 and 149 are reversed with respect to each other and interlocked as shown in FIGS. 12 and 14.

Until the shackle 144 is inserted into engagement with the lock body 140, the interconnected first and second lock sections 148 and 149 may be separated from each other by disengaging the teeth 176 and 176A while moving the first and second lock sections 148 and 149 away from each other.

When the first and second lock sections 148 and 149 are interconnected as shown in FIGS. 12 and 14, the ends 147 and 149 of the shackle legs 145 and 146 may be inserted through the aligned bores 161 and 163A, and 163 and 161A in the lock sections 148 and 149. The ends 147 and 149 of the shackle legs 145 and 146 are inserted through the push nut 74 and 75 into the interior of the lock body 142 as shown in FIG. 14. The angled arrangement of the spring fingers 78 of each push nut 74 and 75 prevents the shackle legs 145 and 146 from being withdrawn from the lock body 142.

The lock 140 uniquely encompasses the ends 147 and 149 of the shackle legs 145 and 146 when the shackle 144 is secured to the lock body 142 as seen in FIGS. 12 and 14. This increases the security of the lock 140 by preventing any contact with the ends 147 and 148 of the shackle legs 145 and 146, such as in unauthorized attempt to remove the lock 140. This is achieved by providing the sidewalls 150 and 150A of the lock sections 148 and 149, respectively, with a sufficient length to enable the ends 147 and 149 of the shackle legs 145 and 146 to be inserted to any desired position within the lock body 142 before contacting or even bottoming out on the lower most endwall sections 160 and 160A.

What is claimed is:

1. A lock apparatus comprising:
a shackle having a pair of spaced legs;
a lock body having a pair of spaced bores for receiving the legs of the shackle; and
at least one push nut carried within the lock body for receiving one leg of the shackle in a unidirectional engagement.

2. The lock apparatus of claim 1 wherein:
the at least one push nut is a pair of push nuts carried in the lock body, each push nut receiving one leg of the shackle.

3. The lock apparatus of claim 1 wherein:
the at least one push nut is captured within the lock body.

4. The lock apparatus of claim 1 wherein:
lock body includes first and second inter-engageable sections.

5. The lock apparatus of claim 4 wherein:
each of the first and second sections have first and second spaced ends, apertures formed in the first and second ends of each of the first and second sections, the apertures aligned coaxially when the first and second sections are inter-engaged to form through bores through the inter-engaged first and second sections.

6. The lock apparatus of claim 4 wherein each of the first and second sections comprises:
a first pair of sidewalls at a first end and a second pair of sidewalls at a second end spaced from the first pair of sidewalls;
the first and second pairs of sidewalls of each of the first and second sections connected into unitary member; and
a coaxially aligned apertures formed in each of the first and second pair of sidewalls.

7. The lock apparatus of claim 6 further comprising:
first and second recesses formed in the first and second sections respectively, between the first and second pairs of sidewalls, the first and second recesses co-axially aligned with the apertures in the first and second pairs of sidewalls.

8. The lock apparatus of claim 7 wherein:
the second pair of sidewalls of each of the first and second sections are laterally spaced closer together than the first pair of sidewalls of the first and second sections; and
the first pair of sidewalls encompassing the second pair of sidewalls when the first and second sections are inter-engaged.

9. The lock apparatus of claim 7 wherein:
one push nut is mounted in each of the first and second section recesses.

10. The lock apparatus of claim 9 wherein:
each recess in the first and second sections cooperates with a like recess in the opposing one of the first and second sections when the first and second sections are inter-engaged to substantially encompass one push nut.

11. The lock apparatus of claim 4 wherein:
the first and second sections are substantially identical.

12. The lock apparatus of claim 4 wherein:
the first and second sections are inter-engageable to form the lock body when one of the first and second sections is reoriented with respect to the other of the first and second sections such that the first pair of sidewalls of the first and second sections are laterally opposed from the second pair of sidewalls from the opposed first and second sections.

13. The lock apparatus of claim 4 further comprising:
engagement members carried on the first and second sections for engaging like engagement members on the opposing first and second sections when the first and second sections are inter-engaged to resist separation of the first and second sections.

14. The lock apparatus of claim 13 wherein the engagement members comprise:
a plurality of spaced, angled teeth.

15. The lock apparatus of claim 13 further comprising:
the engagement members carried on the edges of the first pair of sidewalls of each of the first and second sections.

16. The lock apparatus of claim 4 further comprising:
the lock body defining a closed interior cavity completely encompassing ends of each of the legs of the shackle when the shackle is engaged with the lock body.

17. The lock apparatus of claim 1 wherein:
the lock body defines a unitary, one-piece body.

18. The lock apparatus of claim 17 further comprising:
at least one cavity formed in the lock body;
one push nut disposed within the at least one cavity; and
a slot extending from an exterior surface of the body to the cavity for insertion of the push nut into the cavity.

19. The lock apparatus of claim 1 wherein:
the lock body and the shackle are formed of a castable metal; and
the end of at least one leg of the shackle being frangibly coupled to the lock body.

20. A method of installing a lock including a shackle having spaced legs engageable with a lock body comprising the steps:
providing a lock body with a pair of spaced bores for receiving the legs of the shackle;
mounting at least one push nut within the lock body for receiving one leg of the shackle in a unidirectional insertion direction; and
inserting the legs of the shackle in one direction through the bores in the lock body such that the at least one push nut forcibly engages the at least one leg of the shackle to resist separation of the legs of the shackle from the lock body in a direction opposite from the insertion direction.

21. The method of claim 20 further comprising the steps of:
mounting a pair of push nuts within the lock body, each push nut receiving one leg of the shackle; and
inserting the legs of the shackle in one direction through the bores in the lock body such that each lock nut engages one leg of the shackle to resist separation of the legs of the shackle from the lock body in the direction opposite from the insertion direction.

22. The method of claim 20 further comprising the step of:
inserting the at least one push nut through a slot in the lock body into an internal cavity within the lock body.

23. The method of claim 20 further comprising the step of:
forming the lock body of first and second inter-engageable sections.

24. The method of claim 23 further comprising the step of:
forming a pair of recesses in each section;
mounting a push nut in each of the recesses in one of the sections; and
interengaging the sections to form a unitary lock body, the recesses in each of the sections cooperating to substantially encompass one push nut therebetween.

25. The method of claim 20 further comprising the step of:
forming the lock body with a closed interior chamber encompassing ends of the legs of the shackle when the shackle is engaged with the lock body.
